(19) United States
(12) Patent Application Publication
(10) Pub. No.: US 2020/0050481 A1
(43) Pub. Date: Feb. 13, 2020

(54) Computing Method Applied to Artificial Intelligence Chip, and Artificial Intelligence Chip

(71) Applicant: Beijing Baidu Netcom Science and Technology Co., Ltd., Beijing (CN)

(72) Inventors: Jian Ouyang, Beijing (CN); Xueliang Du, Beijing (CN); Yingnan Xu, Beijing (CN); Huimin Li, Beijing (CN)

(21) Appl. No.: 16/506,099

(22) Filed: Jul. 9, 2019

(30) Foreign Application Priority Data
Aug. 10, 2018 (CN) 201810906485.9

(51) Int. Cl. G06F 9/48; G06F 9/30; G06F 9/38; G06F 9/34

(52) U.S. Cl. CPC G06F 9/4881; G06F 9/30196; G06F 9/3836; G06F 17/11; G06F 9/3013; G06F 9/34; G06F 9/3877

(57) ABSTRACT

Disclosed are a computing method applied to an artificial intelligence chip and the artificial intelligence chip. The method includes: a target processor core generating, in response to determining a computational identifier obtained by decoding a to-be-executed instruction being a preset complex computational identifier, a complex computational instruction using the computational identifier and at least one operand obtained by decoding, and adding the generated complex computational instruction to a complex computational instruction queue; and a computational accelerator selecting a complex computational instruction from the complex computational instruction queue, executing a complex computation indicated by the complex computational identifier in the selected complex computational instruction using the at least one operand in the selected complex computational instruction as an inputted parameter, to obtain computational result; and writing the obtained computational result as a complex computational result into a complex computational result queue.

### CROSS-REFERENCE TO RELATED APPLICATION

This application claims priority to Chinese Patent Application No. 201810906485.9 filed Aug. 10, 2018, the disclosure of which is hereby incorporated by reference in its entirety.

### TECHNICAL FIELD

Embodiments of the present disclosure relate to the field of computer technology, and particularly to a computing method applied to an artificial intelligence chip, and the artificial intelligence chip.

### BACKGROUND

The artificial intelligence chip, i.e., AI (Artificial Intelligence) chip, also referred to as an AI accelerator or computing card, is a module specially used for processing a large number of computational tasks in artificial intelligence applications (other non-computational tasks are still processed by the CPU). There is a huge demand for complex computation in AI computation. In particular, the demand for complex computation has greater impacts on the computational performance. Complex computation may be implemented by a basic computational instruction, but will reduce the execution efficiency of the complex computation (e.g., floating point square root extraction, floating point exponentiation, or trigonometric function computation).

### SUMMARY

Embodiments of the present disclosure present a computing method applied to an artificial intelligence chip, and the artificial intelligence chip.

In a first aspect, an embodiment of the present disclosure provides a computing method applied to an artificial intelligence chip, including: decoding, by a target processor core among the at least one processor core, a to-be-executed instruction to obtain a computational identifier and at least one operand; generating, by the target processor core, a complex computational instruction using the computational identifier and the at least one operand obtained by the decoding in response to determining that the computational identifier obtained by decoding is a preset complex computational identifier; adding, by the target processor core, the generated complex computational instruction to a complex computational instruction queue; selecting, by the computational accelerator, a complex computational instruction from the complex computational instruction queue; executing, by the computational accelerator, a complex computation indicated by the complex computational identifier in the selected complex computational instruction using at least one operand in the selected complex computational instruction as an inputted parameter, to obtain a computational result; and writing, by the computational accelerator, the obtained computational result as a complex computational result into a complex computational result queue.

In some embodiments, before decoding, by a target processor core among the at least one processor core, a to-be-executed instruction, the method further includes: selecting, in response to receiving the to-be-executed instruction, a processor core executing the to-be-executed instruction from the at least one processor core for use as the target processor core.

In some embodiments, the complex computational instruction queue includes a complex computational instruction queue corresponding to each of the at least one processor core, and the complex computational result queue includes a complex computational result queue corresponding to the each of the at least one processor core; and the adding, by the target processor core, the generated complex computational instruction to a complex computational instruction queue includes: adding, by the target processor core, the generated complex computational instruction to a complex computational instruction queue corresponding to the target processor core; and selecting, by the computational accelerator, a complex computational instruction from the complex computational instruction queue includes: selecting, by the computational accelerator, the complex computational instruction from a complex computational instruction queue corresponding to the each of the at least one processor core; and the writing, by the computational accelerator, the obtained computational result as a complex computational result into a complex computational result queue includes: writing, by the computational accelerator, the obtained computational result as the complex computational result into a complex computational result queue corresponding to a processor core corresponding to the complex computational instruction queue of the selected complex computational instruction.

In some embodiments, after writing, by the computational accelerator, the obtained computational result as the complex computational result into a complex computational result queue corresponding to a processor core corresponding to the complex computational instruction queue of the selected complex computational instruction, the method further includes: selecting, by the target processor core, the complex computational result from the complex computational result queue corresponding to the target processor core into at least one of: a result register in the target processor core, or a memory of the artificial intelligence chip.

In some embodiments, the generating, by the target processor core, a complex computational instruction using the computational identifier and the at least one operand obtained by the decoding in response to determining that the computational identifier obtained by decoding is a preset complex computational identifier includes: generating, by the target processor core, the complex computational instruction using the computational identifier, the at least one operand obtained by the decoding, and an identifier of the target processor core, in response to determining that the computational identifier obtained by decoding is the preset complex computational identifier; and writing, by the computational accelerator, the obtained computational result as a complex computational result into a complex computational result queue comprises: writing, by the computational accelerator, the obtained computational result and a processor core identifier in the selected complex computational instruction as the complex computational result into the complex computational result queue.

In some embodiments, after writing, by the computational accelerator, the obtained computational result and a processor core identifier in the selected complex computational instruction as the complex computational result into the complex computational result queue, the method further comprises: selecting, by the target processor core, a computational result in the complex computational result with the processor core identifier being the identifier of the target processor core from the complex computational result queue, and writing the computational result into at least one of: the result register in the target processor core, or the memory of the artificial intelligence chip.

In some embodiments, the computational accelerator includes at least one of the following items: an application specific integrated circuit chip, or a field programmable gate array.

In some embodiments, the complex computational instruction queue and the complex computational result queue are first-in-first-out queues.

In some embodiments, the complex computational instruction queue and the complex computational result queue are stored in a cache.

In some embodiments, the computational accelerator includes at least one computing unit; and the executing, by the computational accelerator, a complex computation indicated by the complex computational identifier in the selected complex computational instruction using at least one operand in the selected complex computational instruction as an inputted parameter includes: executing the complex computation indicated by the complex computational identifier in the selected complex computational instruction using the at least one operand in the selected complex computational instruction as the inputted parameter in a computing unit corresponding to the complex computational identifier in the selected complex computational instruction of the computational accelerator.

In some embodiments, the preset complex computational identifier includes at least one of the following items: an exponentiation identifier, a square root extraction identifier, or a trigonometric function computation identifier.

In a second aspect, an embodiment of the present disclosure provides an artificial intelligence chip, including: at least one processor core; a computational accelerator connected to each of the at least one processor core; a storage apparatus, storing at least one program thereon, where the at least one program, when executed by the artificial intelligence chip, causes the artificial intelligence chip to implement the method according to any one implementation in the first aspect.

In a third aspect, an embodiment of the present disclosure provides a computer readable medium, storing a computer program thereon, where the computer program, when executed by an artificial intelligence chip, implements the method according to any one implementation in the first aspect.

In a fourth aspect, an embodiment of the present disclosure provides an electronic device, including: a processor, a storage apparatus, and at least one the artificial intelligence chip according to the second aspect.

In the computing method applied to an artificial intelligence chip provided in the embodiments of the present disclosure, the artificial intelligence chip includes at least one processor core and a computational accelerator connected to each processor core of the at least one processor core. The method includes: a target processor core, in response to determining computation to be executed by a to-be-executed instruction being preset complex computation, decoding the to-be-executed instruction to obtain a complex computational identifier and at least one operand, generating a complex computational instruction using the complex computational identifier and the at least one operand, and adding the generated complex computational instruction to a complex computational instruction queue, and then the computational accelerator selecting a complex computational instruction from the complex computational instruction queue, executing complex computation indicated by the complex computational identifier in the selected complex computational instruction using the at least one operand in the selected complex computational instruction as an inputted parameter, to obtain a computational result, and writing the obtained computational result as a complex computational result into a complex computational result queue, thereby effectively utilizing the computational accelerator for complex computation. It includes at least the following technical effects.

First, the computational accelerator is introduced to execute complex computation, thereby improving the ability and efficiency of processing complex computation by the AI chip.

Second, because in practice, the execution frequency of complex computation is not as high as the execution frequency of simple computation, the at least one processor core shares one computational accelerator, rather than providing one computational accelerator for each processor core, thereby reducing the area consumption and power consumption caused by complex computation in the AI chip.

Third, since there is a plurality of computing units in the computational accelerator, and the plurality of computing units executes complex computational operations in parallel, the time consumption of complex computation may be masked by subsequent instructions when there are no data risks.

### BRIEF DESCRIPTION OF THE DRAWINGS

By reading detailed descriptions of non-limiting embodiments with reference to the following accompanying drawings, other features, objectives and advantages of the present disclosure will become more apparent:

FIG. 1 is an architectural diagram of an exemplary system in which an embodiment of the present disclosure may be applied;

FIG. 2 is a flowchart of an embodiment of a computing method applied to an artificial intelligence chip according to the present disclosure;

FIG. 3A is a flowchart of another embodiment of the computing method applied to an artificial intelligence chip according to the present disclosure;

FIG. 3B is a schematic structural diagram of the artificial intelligence chip of the computing method applied to an artificial intelligence chip according to the embodiment of FIG. 3A;

FIG. 3C is a schematic diagram of a complex computational instruction according to the embodiment of FIG. 3A;

FIG. 3D is a schematic diagram of complex computation result according to the embodiment of FIG. 3A;

FIG. 4A is a flowchart of still another embodiment of the computing method applied to an artificial intelligence chip according to the present disclosure;

FIG. 4B is a schematic structural diagram of the artificial intelligence chip of the computing method applied to an artificial intelligence chip according to the embodiment of FIG. 4A;

FIG. 4C is a schematic diagram of a complex computational instruction according to the embodiment of FIG. 4A;

FIG. 4D is a schematic diagram of complex computation result according to the embodiment of FIG. 4A; and

FIG. 5 is a schematic structural diagram of a computer system adapted to implement an electronic device of the embodiments of the present disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present disclosure and the features in the embodiments may be combined with each other on a non-conflict basis. The present disclosure will be described below in detail with reference to the accompanying drawings and in combination with the embodiments.

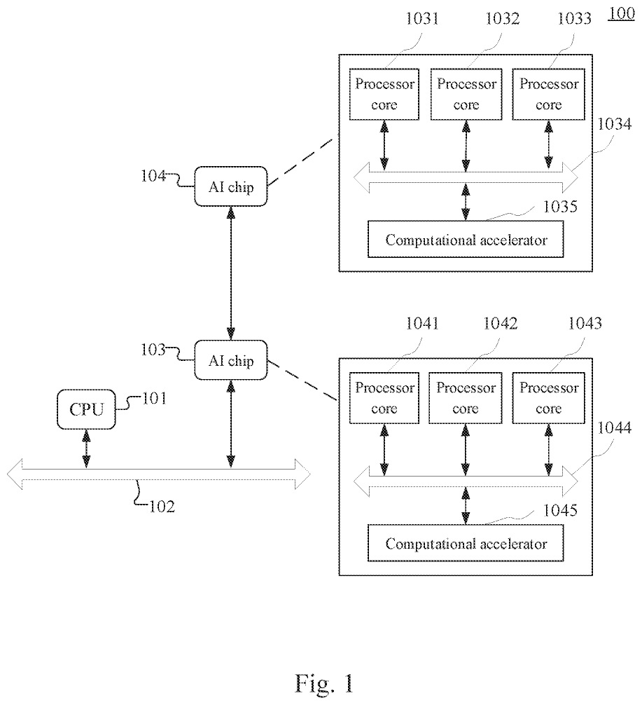

FIG. 1 shows an exemplary system architecture 100 in which an embodiment of a computing method applied to an artificial intelligence chip of the present disclosure may be implemented.

As shown in FIG. 1, the system architecture 100 may include a CPU (Central Processing Unit) 101, a bus 102, and AI chips 103 and 104. The bus 102 serves as a medium providing a communication link between the CPU 101 and the AI chips 103 and 104. The bus 102 may include various bus types, e.g., an AMBA (Advanced Microcontroller Bus Architecture) bus, and an OCP (Open Core Protocol) bus.

The AI chip 103 may include processor cores 1031, 1032, and 1033, a wire 1034, and a computational accelerator 1035. The wire 1034 serves as a medium providing a communication link between the processor cores 1031, 1032, and 1033, and the computational accelerator 1035. The wire 1034 may include various wire types, such as a PCI bus, a PCIE bus, an AMBA bus supporting network on chip protocol, the OCP bus, and other network on chip bus.

The AI chip 104 may include processor cores 1041, 1042, and 1043, a wire 1044, and a computational accelerator 1045. The wire 1044 serves as a medium providing a communication link between the processor cores 1041, 1042, and 1043, and the computational accelerator 1045. The wire 1044 may include various wire types, such as the PCI bus, the PCIE bus, the AMBA bus supporting network on chip protocol, the OCP bus, and other network on chip bus.

It should be noted that the computing method applied to an artificial intelligence chip provided in the embodiment of the present disclosure is generally executed by the AI chips 102 and 103.

It should be understood that the numbers of CPUs, buses, and AI chips in FIG. 1 are merely illustrative. Any number of CPUs, buses, and AI chips may be provided based on actual requirements. Similarly, the numbers of processor cores, wires, and memories in the AI chips 102 and 103 are merely illustrative, too. Any number of processor cores, wires, and memories may be provided in the AI chips 102 and 103 based on actual requirements. In addition, according to actual requirements, the system architecture 100 may further include a memory, an input device (such as a mouse, or a keyboard), an output device (such as a displayer, or a speaker), an input/output interface, and the like.

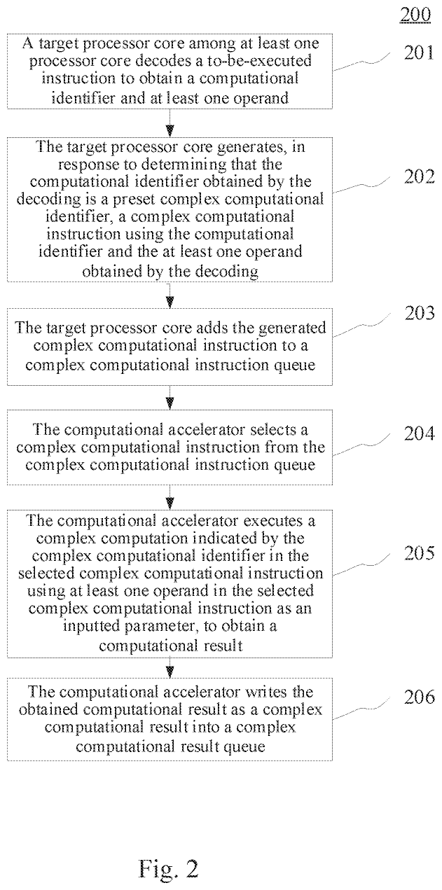

Further referring to FIG. 2, a process 200 of an embodiment of a computing method applied to an artificial intelligence chip according to the present disclosure is shown. The computing method applied to an artificial intelligence chip includes the following steps.

Step 201: A target processor core among at least one processor core decodes a to-be-executed instruction to obtain a computational identifier and at least one operand.

In the present embodiment, an executing body (e.g., the AI chip shown in FIG. 1) of the computing method applied to an artificial intelligence chip may include at least one processor core and a computational accelerator connected to each processor core among the at least one processor core. The computational accelerator has independent computing capacity, and is more applicable to complex computation with respect to the processor core. Here, the complex computation refers to computation with huge computational workload with respect to simple computation, while the simple computation may refer to computation with small computational workload. For example, the simple computation may be additive operation, multiplication, or computation of simple combination of additive operation and multiplication. A general processor core includes an adder and a multiplier. Therefore, the processor core is more suitable for the simple computation. The complex computation refers to computation that cannot be constituted by simple combination of additive operation and multiplication, such as exponentiation, square root extraction, and trigonometric function computation.

In some optional implementations of the present embodiment, the computational accelerator may include at least one of the following items: an Application Specific Integrated Circuit (ASIC) chip or a Field Programmable Gate Array (FPGA).

Here, the executing body may, when receiving the to-be-executed instruction, select a processor core executing the to-be-executed instruction from the at least one processor core for use as the target processor core. For example, the executing body may select the processor core executing the to-be-executed instruction from the at least one processor core based on the current work state of each processor core, for use as the target processor core. For another example, the executing body may select the processor core executing the to-be-executed instruction from the at least one processor core by polling, for use as the target processor core.

Thus, the target processor core may decode the to-be-executed instruction when receiving the to-be-executed instruction, to obtain a computational identifier and at least one operand. Here, the computational identifier may be used to uniquely identify various kinds of computation that may be executed by the processor core. The computational identifier may include at least one of the following items: a number, a letter, or a symbol.

Step 202: The target processor core generates, in response to determining that the computational identifier obtained by the decoding is a preset complex computational identifier, a complex computational instruction using the computational identifier and the at least one operand obtained by the decoding.

In the present embodiment, the target processor core may determine whether the computational identifier obtained by decoding is the preset complex computational identifier after decoding the to-be-executed instruction to obtain the computational identifier and the at least one operand. If it is determined that the computational identifier obtained by decoding is a preset complex computational identifier, then the target processor core may generate a complex computational instruction using the computational identifier and the at least one operand obtained by decoding.

Specifically, here, each processor core may pre-store a preset complex computational identifier set, so that the target processor core may determine whether the computational identifier obtained by decoding belongs to the preset complex computational identifier set. If it is determined that the computational identifier obtained by decoding belongs to the preset complex computational identifier set, then the target processor core may determine that the computational identifier obtained by decoding is the preset complex computational identifier; while if it is determined that the computational identifier obtained by decoding does not belong to the preset complex computational identifier set, then the target processor core may determine that the computational identifier obtained by decoding is not the preset complex computational identifier.

Here, the complex computational identifier set maybe a complex computational identifier set formed by a skilled person using computational identifiers of computation with huge computational workload involved in commonly used computation of AI computation as complex computational identifiers based on computational requirements in practical application.

In some embodiments, the preset complex computational identifier may include at least one of the following items: an exponentiation identifier, a square root extraction identifier, or a trigonometric function computation identifier.

Step 203: The target processor core adds the generated complex computational instruction to a complex computational instruction queue.

In the present embodiment, the target processor core may add the complex computational instruction generated in step 202 to a complex computational instruction queue. Here, the complex computational instruction queue stores to-be-executed complex computational instructions.

In some optional implementations of the present embodiment, the complex computational instruction queue may also be a first-in-first-out queue.

In some optional implementations of the present embodiment, the complex computational instruction queue may be stored in a cache, and the cache here may be connected to the target processor core and the computational accelerator respectively by wired connection. Thus, the target processor core may add the generated complex computational instruction to the complex computational instruction queue, and in the following step 204, the computational accelerator may also select a complex computational instruction from the complex computational instruction queue.

Step 204: The computational accelerator selects a complex computational instruction from the complex computational instruction queue.

In the present embodiment, the computational accelerator may select a complex computational instruction from the complex computational instruction queue by various implementation approaches. For example, the computing component may select the complex computational instruction from the complex computational instruction queue in a first-in-first-out order.

Step 205: The computational accelerator executes a complex computation indicated by the complex computational identifier in the selected complex computational instruction using at least one operand in the selected complex computational instruction as an inputted parameter, to obtain a computational result.

In the present embodiment, based on the complex computational instruction selected in step 204, the computational accelerator may execute complex computation indicated by the complex computational identifier in the selected complex computational instruction using the at least one operand in the selected complex computational instruction as the inputted parameter, to obtain computational result.

In some alternative implementations of the present embodiment, the computational accelerator may include at least one computing unit. Thus, step 205 may be performed as follows: executing the complex computation indicated by the complex computational identifier in the selected complex computational instruction using the at least one operand in the selected complex computational instruction as the inputted parameter in a computing unit corresponding to the complex computational identifier in the selected complex computational instruction of the computational accelerator.

Step 206: The computational accelerator writes the obtained computational result as a complex computational result into a complex computational result queue.

In the present embodiment, the computational accelerator uses the computational result obtained from executing the complex computation in step 205 as the complex computational result and writes the complex computational result into the complex computational result queue.

Here, the complex computational result queue stores the complex computational result obtained by executing, by the computational accelerator, the complex computation.

In some optional implementations of the present embodiment, the complex computational result queue may be a first-in-first-out queue.

In some optional implementations of the present embodiment, the complex computational result queue may be stored in the cache, and the cache here may be connected to the target processor core and the computational accelerator respectively by wired connection. Thus, the computational accelerator may write the complex computational result into the complex computational result queue. Moreover, the target processor core may also read the complex computational result from the complex computational result queue.

The method provided in the above embodiments of the present disclosure includes: a target processor core, in response to determining computation to be executed by a to-be-executed instruction being preset complex computation, decoding the to-be-executed instruction to obtain a complex computational identifier and at least one operand, generating a complex computational instruction using the complex computational identifier and the at least one operand, and adding the generated complex computational instruction to a complex computational instruction queue, and then a computational accelerator selecting a complex computational instruction from the complex computational instruction queue, executing complex computation indicated by the complex computational identifier in the selected complex computational instruction using the at least one operand in the selected complex computational instruction as an inputted parameter, to obtain computational result, and writing the obtained computational result as complex computational result into a complex computational result queue, thereby effectively utilizing the computational accelerator for complex computation. It includes at least the following technical effects.

First, the computational accelerator is introduced to execute complex computation, thereby improving the ability and efficiency of processing complex computation by the AI chip.

Second, because in practice, the execution frequency of complex computation is not as high as the execution frequency of simple computation, the at least one processor core shares one computational accelerator, rather than providing one computational accelerator for each processor core, thereby reducing the area consumption and power consumption caused by complex computation in the AI chip.

Third, since there is a plurality of computing units in the computational accelerator, and the plurality of computing units executes complex computational operations in parallel, the time consumption of complex computation may be masked by subsequent instructions when there are no data risks.

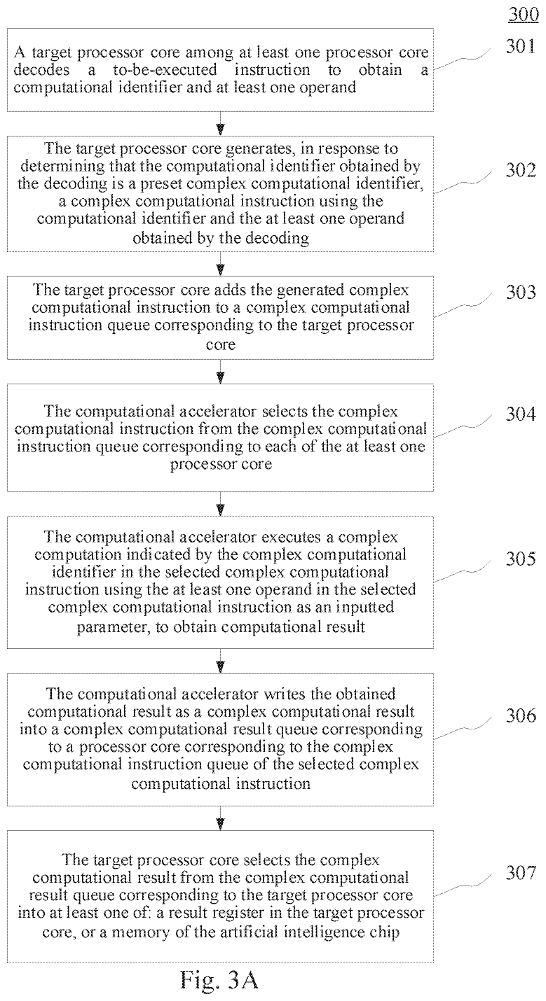

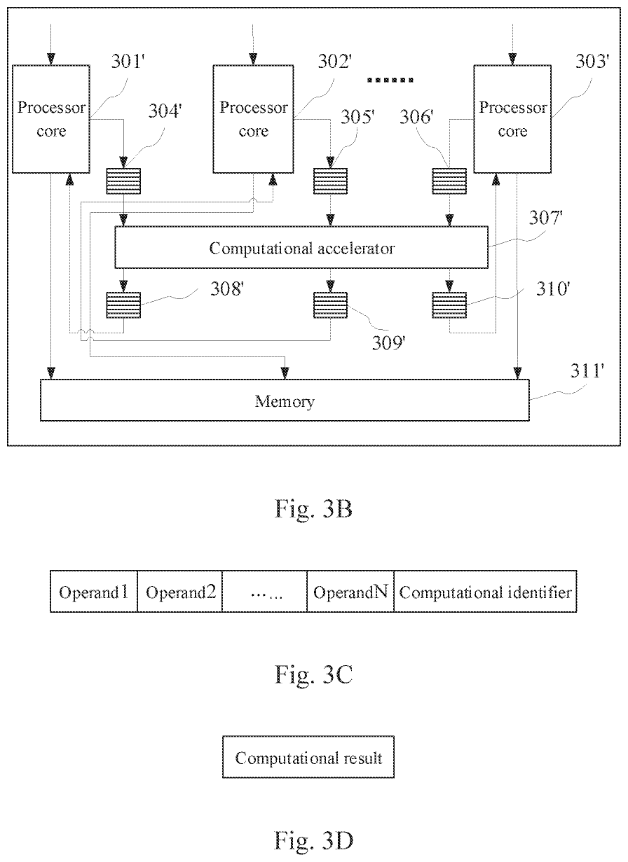

Further referring to FIG. 3A, a process 300 of another embodiment of the computing method applied to an artificial intelligence chip is shown. The process 300 of the computing method applied to an artificial intelligence chip includes the following steps.

Step 301: A target processor core among at least one processor core decodes a to-be-executed instruction to obtain a computational identifier and at least one operand.

In the present embodiment, an executing body (e.g., the AI chip shown in FIG. 1) of the computing method applied to an artificial intelligence chip may include at least one processor core and a computational accelerator connected to each processor core among the at least one processor core. The computational accelerator has independent computing capacity, and is more applicable to complex computation with respect to the processor core. Here, the complex computation refers to computation with huge computational workload with respect to simple computation, while the simple computation may refer to computation with small computational workload.

Step 302: The target processor core generates, in response to determining that the computational identifier obtained by the decoding is a preset complex computational identifier, a complex computational instruction using the computational identifier and the at least one operand obtained by the decoding.

Specific operations in step 301 and step 302 in the present embodiment are basically identical to the operations in step 201 and step 202 in the embodiment shown in FIG. 2, and the description will not be repeated here.

Step 303: The target processor core adds the generated complex computational instruction to a complex computational instruction queue corresponding to the target processor core.

In the present embodiment, each processor core among the at least one processor core corresponds to a complex computational instruction queue. Each processor core may be connected to the computational accelerator via a corresponding complex computational instruction queue. Thus, the target processor core may add the complex computational instruction generated in step 402 to the complex computational instruction queue corresponding to the target processor core.

Step 304: The computational accelerator selects the complex computational instruction from the complex computational instruction queue corresponding to each of the at least one processor core.

In the present embodiment, the computational accelerator may select the complex computational instruction from the complex computational instruction queue corresponding to each of the at least one processor core by various implementation approaches. For example, the computational accelerator may poll in the complex computational instruction queue corresponding to each of the at least one processor core, and select preset number (e.g., one) instructions from the complex computational instruction queue corresponding to one processor core each time in a first-in-first-out order.

Step 305: The computational accelerator executes a complex computation indicated by the complex computational identifier in the selected complex computational instruction using the at least one operand in the selected complex computational instruction as an inputted parameter, to obtain computational result.

Specific operations in step 305 in the present embodiment are basically identical to the operations in step 205 in the embodiment shown in FIG. 2, and the description will not be repeated here.

Step 306: The computational accelerator writes the obtained computational result as a complex computational result into a complex computational result queue corresponding to a processor core corresponding to the complex computational instruction queue of the selected complex computational instruction.

In the present embodiment, each of the at least one processor core corresponds to a complex computational result queue. Each processor core may be connected to the computational accelerator via a corresponding complex computational result queue. Thus, the computational accelerator writes the computational result obtained in step 305 as the complex computational result into the complex computational result queue corresponding to the processor core corresponding to the complex computational instruction queue of the complex computational instruction selected in step 304.

In some optional implementations of the present embodiment, the computing method applied to an artificial intelligence chip may further include the following step 307.

Step 307: The target processor core selects the complex computational result from the complex computational result queue corresponding to the target processor core into at least one of: a result register in the target processor core, or a memory of the artificial intelligence chip.

Here, the target processor core may be provided with the result register for storing the computational result. Thus, after step 306, the target processor core may select the complex computational result from the complex computational result queue corresponding to the target processor core into at least one of: the result register in the target processor core, or the memory of the artificial intelligence chip.

Here, the memory of the artificial intelligence chip may include at least one of the following items: a Static Random-Access Memory (SRAM), a Dynamic Random Access Memory (DRAM), or a flash memory.

Further referring to FIG. 3B, FIG. 3B is a schematic structural diagram of the artificial intelligence chip of the computing method applied to an artificial intelligence chip according to the present embodiment. As shown FIG. 3B, the artificial intelligence chip may include processor cores 301′, 302′ and 303′, complex computational instruction queues 304′, 305′ and 306′, a computational accelerator 307′, complex computational result queues 308′, 309′ and 310′, and a memory 311′. The processor cores 301′, 302′ and 303′ are respectively connected to the complex computational instruction queues 304′, 305′ and 306′ by wired connection, the complex computational instruction queues 304′, 305′ and 306′ are respectively connected to the computational accelerator 307′ by wired connection, the computational accelerator 307′ is connected to the complex computational result queues 308′, 309′ and 310′ by wired connection, the complex computational result queues 308′, 309′ and 310′ are respectively connected to the processor cores 301′, 302′ and 303′ by wired connection, and the processor cores 301′, 302′ and 303′ are respectively connected to the memory 311′ by wired connection. A result register (not shown in FIG. 3B) may be further provided within the processor cores 301′, 302′ and 303′, respectively.

Thus, assuming that the processor core 301′ is a target processor core, then the processor core 301′ may, when receiving a to-be-executed instruction, first decode the to-be-executed instruction to obtain a computational identifier and at least one operand, then determine that the computational identifier obtained by decoding is a trigonometric function computation identifier, the trigonometric function computation identifier being a preset complex computational identifier, and then generate a complex computational instruction using the computational identifier obtained by decoding, i.e., the trigonometric function computation identifier, and the at least one operand. As shown in FIG. 3C, FIG. 3C is a schematic diagram of a complex computational instruction. Then, the processor core 301′ adds the generated complex computational instruction to the complex computational instruction queue 304′ corresponding to the processor core. Then, the computational accelerator 307′ selects a complex computational instruction from the complex computational instruction queues 304′, 305′ and 306′. Then, the computational accelerator 307′ executes a complex computation indicated by the complex computational identifier in the selected complex computational instruction using the at least one operand in the selected complex computational instruction as an inputted parameter, to obtain a computational result. Finally, the computational accelerator 307′ writes the obtained computational result as a complex computational result into a complex computational result queue 308′. As shown in FIG. 3D, FIG. 3D is a schematic diagram of a complex computational result. Optionally, the processor core 301′ may further select a complex computational result from the complex computational result queue 304′ corresponding to the processor core 301′ into at least one of: the result register in the target processor core 301′, or the memory 311′ of the artificial intelligence chip.

As may be seen in FIG. 3A, compared to the embodiment corresponding to FIG. 2, in the process 300 of the computing method applied to an artificial intelligence chip in the present embodiment, each processor core is provided with a corresponding complex computational instruction queue and a corresponding complex computational result queue. Therefore, the solution described in the present embodiment provides a specific solution to implementing computation applied to the artificial intelligence chip.

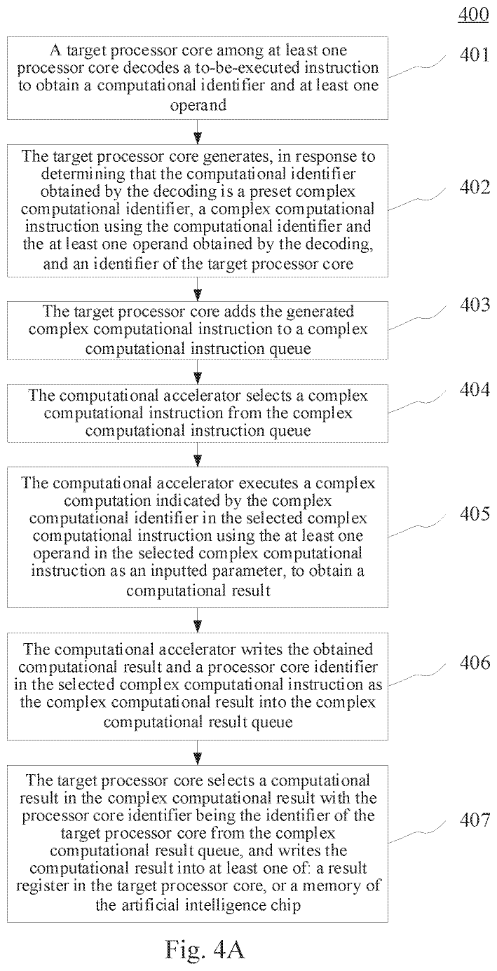

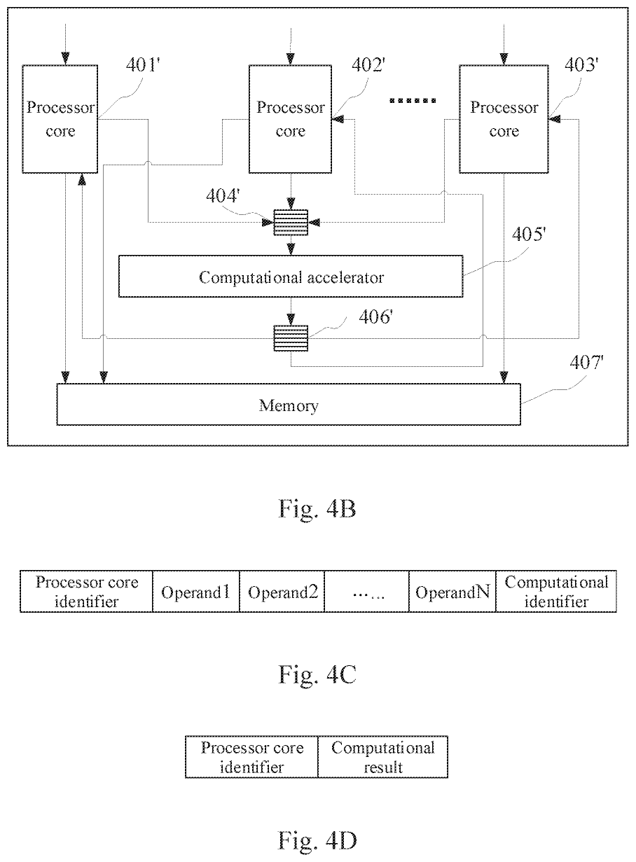

Further referring to FIG. 4A, a process 400 of still another embodiment of the computing method applied to an artificial intelligence chip is shown. The process 400 of the computing method applied to an artificial intelligence chip includes the following steps.

Step 401: A target processor core among at least one processor core decodes a to-be-executed instruction to obtain a computational identifier and at least one operand.

In the present embodiment, an executing body (e.g., the AI chip shown in FIG. 1) of the computing method applied to an artificial intelligence chip may include at least one processor core and a computational accelerator connected to each of the at least one processor core. The computational accelerator has independent computing capacity, and is more applicable to complex computation with respect to the processor core. Here, the complex computation refers to computation with huge computational workload with respect to simple computation, while the simple computation may refer to computation with small computational workload.

Specific operations in step 401 in the present embodiment are basically identical to the operations in step 201 in the embodiment shown in FIG. 2, and the description will not be repeated here.

Step 402: The target processor core generates, in response to determining that the computational identifier obtained by the decoding is a preset complex computational identifier, a complex computational instruction using the computational identifier and the at least one operand obtained by the decoding, and an identifier of the target processor core.

In the present embodiment, the target processor core may determine whether the computational identifier obtained by decoding is a preset complex computational identifier, after decoding the to-be-executed instruction to obtain the computational identifier and the at least one operand. If it is determined that the computational identifier obtained by decoding is the preset complex computational identifier, then the target processor core may generate a complex computational instruction using the computational identifier, the at least one operand obtained by decoding, and the identifier of the target processor core.

Step 403: The target processor core adds the generated complex computational instruction to a complex computational instruction queue.

Step 404: The computational accelerator selects a complex computational instruction from the complex computational instruction queue.

Step 405: The computational accelerator executes a complex computation indicated by the complex computational identifier in the selected complex computational instruction using the at least one operand in the selected complex computational instruction as an inputted parameter, to obtain a computational result.

Specific operations in steps 403, 404 and 405 in the present embodiment are basically identical to the operations insteps 203, 204 and 205 in the embodiment shown in FIG. 2, and the description will not be repeated here.

Step 406: The computational accelerator writes the obtained computational result and a processor core identifier in the selected complex computational instruction as the complex computational result into the complex computational result queue.

In the present embodiment, the computational accelerator may write the computational result obtained by executing the complex computation in step 405 and the processor core identifier in the selected complex computational instruction as the complex computational result into the complex computational result queue.

Here, the complex computational result queue stores the complex computational result obtained by executing, by computational accelerator, the complex computation.

In some optional implementations of the present embodiment, the computing method applied to an artificial intelligence chip may further include the following step 407.

Step 407: The target processor core selects a computational result in the complex computational result with the processor core identifier being the identifier of the target processor core from the complex computational result queue, and writes the computational result into at least one of: a result register in the target processor core, or a memory of the artificial intelligence chip.

Here, the target processor core may be provided with the result register for storing the computational result. Thus, after step 406, the target processor core may select computational result in the complex computational result with the processor core identifier being the identifier of the target processor core from the complex computational result queue, and write the computational result into at least one of: the result register in the target processor core, or the memory of the artificial intelligence chip.

Here, the memory of the artificial intelligence chip may include at least one of the following items: a static random-access memory, a dynamic random access memory, or a flash memory.

Further referring to FIG. 4B, FIG. 4B is a schematic structural diagram of the artificial intelligence chip of the computing method applied to an artificial intelligence chip according to the present embodiment. As shown FIG. 4B, the artificial intelligence chip may include processor cores 401′, 402′ and 403′, a complex computational instruction queue 404′, a computational accelerator 405′, a complex computational result queue 406′, and a memory 407′. The processor cores 401′, 402′ and 403′ are respectively connected to the complex computational instruction queue 404′ by wired connection, the complex computational instruction queue 404′ is connected to the computational accelerator 405′ by wired connection, the computational accelerator 405′ is connected to the complex computational result queue 406′ by wired connection, the complex computational result queue 406′ is connected to the processor cores 401′, 402′ and 403′ by wired connection, and the processor cores 401′, 402′ and 403′ are respectively connected to the memory 407′ by wired connection. A result register (not shown in FIG. 4B) may be further provided within the processor cores 401′, 402′ and 403′, respectively.

Thus, assuming that the processor core 401′ is a target processor core, then the processor core 401′ may, when receiving a to-be-executed instruction, first decode the to-be-executed instruction to obtain a computational identifier and at least one operand, then determine that the computational identifier obtained by decoding is a trigonometric function computation identifier, the trigonometric function computation identifier being a preset complex computational identifier, and then generate a complex computational instruction using the computational identifier obtained by decoding, i.e., the trigonometric function computation identifier, the at least one operand, and a processor core identifier of the processor core 401′. As shown in FIG. 4C, FIG. 4C is a schematic diagram of a complex computational instruction. Then, the processor core 401′ adds the generated complex computational instruction to the complex computational instruction queue 404′. Then, the computational accelerator 405′ selects a complex computational instruction from the complex computational instruction queues 404′. Then, the computational accelerator 405′ executes a complex computation indicated by the complex computational identifier in the selected complex computational instruction using the at least one operand in the selected complex computational instruction as an inputted parameter, to obtain a computational result. Finally, the computational accelerator 405′ writes the obtained computational result and the processor core identifier in the selected complex computational instruction as a complex computational result into the complex computational result queue 406′. As shown in FIG. 4D, FIG. 4D is a schematic diagram of a complex computational result. Optionally, the processor core 401′ may further select a computational result in the complex computational result with the processor core identifier being the processor core identifier of the processor core 401′ from the complex computational result queue, and write the computational result into at least one of: the result register in the processor core 401′, or the memory 407′ of the artificial intelligence chip.

As may be seen in FIG. 4A, compared to the embodiment corresponding to FIG. 3, in the process 400 of the computing method applied to an artificial intelligence chip in the present embodiment, at least one processor core shares a complex computational instruction queue and a complex computational result queue. Therefore, the solution described in the present embodiment may further reduce the area consumption and power consumption of the AI chip, with respect to the embodiment corresponding to FIG. 3A.

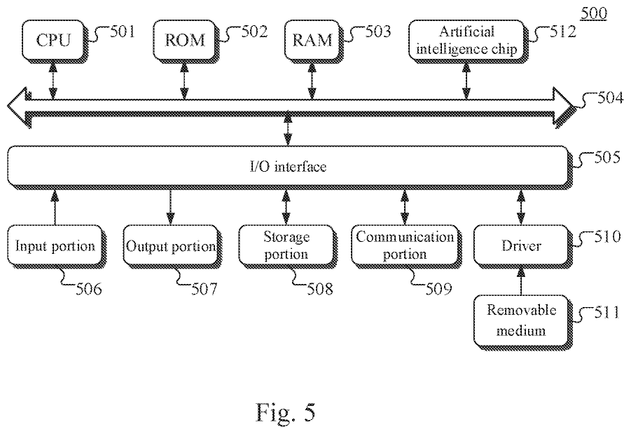

Referring to FIG. 5 below, a schematic structural diagram of a computer system 500 adapted to implement an electronic device of embodiments of the present disclosure is shown. The electronic device shown in FIG. 5 is merely an example, and should not limit the functions and scope of use of the embodiments of the present disclosure.

As shown in FIG. 5, the computer system 500 includes a Central Processing Unit (CPU) 501, which may execute various appropriate actions and processes in accordance with a program stored in a read only memory (ROM) 502 or a program loaded into a random access memory (RAM) 503 from a storage portion 508. The RAM 503 also stores various programs and data required by operations of the system 500. The CPU 501 may also perform data processing and analyzing by at least one artificial intelligence chip 512. The CPU 501, the ROM 502, the RAM 503, and the artificial intelligence chip 512 are connected to each other through a bus 504. An input/output (I/O) interface 505 is also connected to the bus 504.

The following components are connected to the I/O interface 505: an input portion 506 including a keyboard, a mouse, or the like; an output portion 507 including a Cathode Ray Tube (CRT), a Liquid Crystal Display (LCD), a speaker, or the like; a storage portion 508 including a hard disk, or the like; and a communication portion 509 including a network interface card, such as a LAN (Local Area Network) card and a modem. The communication portion 509 performs communication processes via a network, such as the Internet. A driver 510 is also connected to the I/O interface 505 as required. A removable medium 511, such as a magnetic disk, an optical disk, a magneto-optical disk, and a semiconductor memory, may be installed on the driver 510, so that a computer program read therefrom is installed on the storage portion 508 as needed.

In particular, according to embodiments of the present disclosure, the process described above with reference to the flow chart maybe implemented in a computer software program. For example, an embodiment of the present disclosure includes a computer program product, which comprises a computer program that is tangibly embedded in a computer readable medium. The computer program includes program codes for executing the method as illustrated in the flow chart. In such an embodiment, the computer program may be downloaded and installed from a network via the communication portion 509, and/or may be installed from the removable medium 511. The computer program, when executed by the central processing unit (CPU) 501, implements the above functions as defined by the method of the present disclosure. It should be noted that the computer readable medium according to the present disclosure may be a computer readable signal medium or a computer readable storage medium or any combination of the above two. An example of the computer readable storage medium may include, but is not limited to: an electric, magnetic, optical, electromagnetic, infrared, or semiconductor system, apparatus, element, or a combination of any of the above. A more specific example of the computer readable storage medium may include, but is not limited to: electrical connection with one or more wire, a portable computer disk, a hard disk, a random access memory (RAM), a read only memory (ROM), an erasable programmable read only memory (EPROM or flash memory), an optical fiber, a portable compact disk read only memory (CD-ROM), an optical memory, a magnetic memory, or any suitable combination of the above. In the present disclosure, the computer readable storage medium may be any tangible medium containing or storing programs, which may be used by a command execution system, apparatus or element, or incorporated thereto. In the present disclosure, the computer readable signal medium may include a data signal in the base band or propagating as a part of a carrier wave, in which computer readable program codes are carried. The propagating data signal may take various forms, including but not limited to: an electromagnetic signal, an optical signal, or any suitable combination of the above. The computer readable signal medium may also be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium, including but not limited to: wireless, wired, optical cable, RF medium, etc., or any suitable combination of the above.

A computer program code for executing operations in the present disclosure may be compiled using one or more programming languages or combinations thereof. The programming languages include object-oriented programming languages, such as Java, Smalltalk or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In the circumstance involving a remote computer, the remote computer may be connected to a user's computer through any network, including local area network (LAN) or wide area network (WAN), or may be connected to an external computer (for example, connected through the Internet using an Internet service provider).

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logical functions. It should also be noted that, in some alternative implementations, the functions denoted by the blocks may occur in a sequence different from the sequences shown in the figures. For example, any two blocks presented in succession may be executed substantially in parallel, or they may sometimes be executed in a reverse sequence, depending on the functions involved. It should also be noted that each block in the block diagrams and/or flow charts as well as a combination of blocks in the block diagrams and/or flow charts may be implemented using a special purpose hardware-based system executing specified functions or operations, or by a combination of special purpose hardware and computer instructions.

In another aspect, the present disclosure further provides a computer readable medium. The computer readable medium stores one or more programs. When executed by an artificial intelligence chip, the one or more programs cause, in the artificial intelligence chip: a target processor core among at least one processor core to decode a to-be-executed instruction to obtain a computational identifier and at least one operand; the target processor core to generate a complex computational instruction using the computational identifier and the at least one operand obtained by decoding in response to determining that the computational identifier obtained by the decoding is a preset complex computational identifier; the target processor core to add the generated complex computational instruction to a complex computational instruction queue; a computational accelerator to select a complex computational instruction from the complex computational instruction queue; the computational accelerator to execute a complex computation indicated by the complex computational identifier in the selected complex computational instruction using at least one operand in the selected complex computational instruction as an inputted parameter, to obtain computational result; and the computational accelerator to write the obtained computational result as a complex computational result into a complex computational result queue.

The above description only provides explanation of the preferred embodiments of the present disclosure and the employed technical principles. It should be appreciated by those skilled in the art that the inventive scope of the present disclosure is not limited to the technical solutions formed by the particular combinations of the above-described technical features. The inventive scope should also cover other technical solutions formed by any combination of the above-described technical features or equivalent features thereof without departing from the concept of the disclosure, for example, technical solutions formed by the above-described features being interchanged with, but not limited to, technical features with similar functions disclosed in the present disclosure.

1. A computing method applied to an artificial intelligence chip, the artificial intelligence chip comprising at least one processor core and a computational accelerator connected to each of the at least one processor core, the method comprising:
decoding, by a target processor core among the at least one processor core, a to-be-executed instruction to obtain a computational identifier and at least one operand;
generating, by the target processor core, a complex computational instruction using the computational identifier and the at least one operand obtained by the decoding, in response to determining that the computational identifier obtained by decoding is a preset complex computational identifier;
adding, by the target processor core, the generated complex computational instruction to a complex computational instruction queue;
selecting, by the computational accelerator, a complex computational instruction from the complex computational instruction queue;
executing, by the computational accelerator, a complex computation indicated by the complex computational identifier in the selected complex computational instruction using at least one operand in the selected complex computational instruction as an inputted parameter, to obtain a computational result; and
writing, by the computational accelerator, the obtained computational result as a complex computational result into a complex computational result queue.

2. The method according to claim 1, wherein before decoding, by a target processor core among the at least one processor core, a to-be-executed instruction, the method further comprises:
selecting, in response to receiving the to-be-executed instruction, a processor core executing the to-be-executed instruction from the at least one processor core for use as the target processor core.

3. The method according to claim 2, wherein the complex computational instruction queue comprises a complex computational instruction queue corresponding to each of the at least one processor core, and the complex computational result queue comprises a complex computational result queue corresponding to each of the at least one processor core; and
the adding, by the target processor core, the generated complex computational instruction to a complex computational instruction queue comprises:
adding, by the target processor core, the generated complex computational instruction to a complex computational instruction queue corresponding to the target processor core; and
the selecting, by the computational accelerator, a complex computational instruction from the complex computational instruction queue comprises:
selecting, by the computational accelerator, the complex computational instruction from a complex computational instruction queue corresponding to the each of the at least one processor core; and
the writing, by the computational accelerator, the obtained computational result as a complex computational result into a complex computational result queue comprises:
writing, by the computational accelerator, the obtained computational result as the complex computational result into a complex computational result queue corresponding to a processor core corresponding to the complex computational instruction queue of the selected complex computational instruction.

4. The method according to claim 3, wherein after writing, by the computational accelerator, the obtained computational result as the complex computational result into a complex computational result queue corresponding to a processor core corresponding to the complex computational instruction queue of the selected complex computational instruction, the method further comprises:
selecting, by the target processor core, the complex computational result from the complex computational result queue corresponding to the target processor core into at least one of: a result register in the target processor core, or a memory of the artificial intelligence chip.

5. The method according to claim 2, wherein the generating, by the target processor core, a complex computational instruction using the computational identifier and the at least one operand obtained by the decoding in response to determining that the computational identifier obtained by decoding is a preset complex computational identifier comprises:
generating, by the target processor core, the complex computational instruction using the computational identifier, the at least one operand obtained by the decoding, and an identifier of the target processor core, in response to determining that the computational identifier obtained by the decoding is the preset complex computational identifier; and
the writing, by the computational accelerator, the obtained computational result as a complex computational result into a complex computational result queue comprises:
writing, by the computational accelerator, the obtained computational result and a processor core identifier in the selected complex computational instruction as the complex computational result into the complex computational result queue.

6. The method according to claim 5, wherein after writing, by the computational accelerator, the obtained computational result and a processor core identifier in the selected complex computational instruction as the complex computational result into the complex computational result queue, the method further comprises:
selecting, by the target processor core, a computational result in the complex computational result with the processor core identifier being the identifier of the target processor core from the complex computational result queue, and writing the computational result into at least one of: the result register in the target processor core, or the memory of the artificial intelligence chip.

7. The method according to claim 1, wherein the computational accelerator comprises at least one of following items: an application specific integrated circuit chip, or a field programmable gate array.

8. The method according to claim 1, wherein the complex computational instruction queue and the complex computational result queue are first-in-first-out queues.

9. The method according to claim 1, wherein the complex computational instruction queue and the complex computational result queue are stored in a cache.

10. The method according to claim 1, wherein the computational accelerator comprises at least one computing unit; and
the executing, by the computational accelerator, a complex computation indicated by the complex computational identifier in the selected complex computational instruction using at least one operand in the selected complex computational instruction as an inputted parameter comprises:
executing the complex computation indicated by the complex computational identifier in the selected complex computational instruction using the at least one operand in the selected complex computational instruction as the inputted parameter in a computing unit corresponding to the complex computational identifier in the selected complex computational instruction of the computational accelerator.

11. The method according to claim 1, wherein the preset complex computational identifier comprises at least one of following items: an exponentiation identifier, a square root extraction identifier, or a trigonometric function computation identifier.

12. An artificial intelligent chip, comprising:
at least one processor core;
a computational accelerator connected to each of the at least one processor core; and
a storage apparatus, storing at least one program thereon, wherein the at least one program, when executed by the artificial intelligence chip, causes the artificial intelligence chip to implement operations, the operations comprising:
decoding, by a target processor core among the at least one processor core, a to-be-executed instruction to obtain a computational identifier and at least one operand;
generating, by the target processor core, a complex computational instruction using the computational identifier and the at least one operand obtained by the decoding, in response to determining that the computational identifier obtained by decoding is a preset complex computational identifier;
adding, by the target processor core, the generated complex computational instruction to a complex computational instruction queue;
selecting, by the computational accelerator, a complex computational instruction from the complex computational instruction queue;
executing, by the computational accelerator, a complex computation indicated by the complex computational identifier in the selected complex computational instruction using at least one operand in the selected complex computational instruction as an inputted parameter, to obtain a computational result; and
writing, by the computational accelerator, the obtained computational result as a complex computational result into a complex computational result queue.

13. A non-transitory computer readable medium, storing a computer program thereon, wherein the program, when executed by an artificial intelligence chip, implements operations, the operations comprising:
decoding, by a target processor core among at least one processor core, a to-be-executed instruction to obtain a computational identifier and at least one operand;
generating, by the target processor core, a complex computational instruction using the computational identifier and the at least one operand obtained by the decoding, in response to determining that the computational identifier obtained by decoding is a preset complex computational identifier;
adding, by the target processor core, the generated complex computational instruction to a complex computational instruction queue;
selecting, by the computational accelerator, a complex computational instruction from the complex computational instruction queue;
executing, by the computational accelerator, a complex computation indicated by the complex computational identifier in the selected complex computational instruction using at least one operand in the selected complex computational instruction as an inputted parameter, to obtain a computational result; and
writing, by the computational accelerator, the obtained computational result as a complex computational result into a complex computational result queue.

14. An electronic device, comprising: a processor, a storage apparatus, and at least one artificial intelligence chip according to claim 12.
